(19) United States
(12) Patent Application Publication
(10) Pub. No.: US 2026/0119541 A1
(43) Pub. Date: Apr. 30, 2026

(54) HYBRID ARCHITECTURE FOR ARTIFICIAL INTELLIGENCE WITH ITERATIVE LOCAL-GLOBAL MODEL FEEDBACK LOOP FOR CONTINUOUS LEARNING

(71) Applicant: BOOMI, LP, Conshohocken, PA (US)

(72) Inventors: Thomas BENJAMIN, Foster City, CA (US); Ayush PARASHAR, Foster City, CA (US); Swagata ASHWANI, San Francisco, CA (US)

(73) Assignee: BOOMI, LP, Conshohocken, PA (US)

(21) Appl. No.: 19/255,212

(22) Filed: Jun. 30, 2025

(30) Foreign Application Priority Data
Oct. 25, 2024 (IN) 202411081538

(51) Int. Cl. G06F 16/3329; G06N 5/022

(52) U.S. Cl. CPC G06F 16/3329; G06N 5/022

(57) ABSTRACT

Traditional artificial intelligence (AI) architectures utilize a centralized approach, in which a single large AI model handles all inference tasks. This approach results in high latency, requires significant computational resources, has difficulty adapting to evolving data, and raises privacy concerns. While hybrid AI architectures have been developed, they suffer from static knowledge bases, limited adaptability, and a lack of continuous learning, which reduces their accuracy. Accordingly, embodiments utilize a hybrid architecture with an iterative local-global model feedback loop for continuous learning during inference. In particular, the local model may escalate inputs to the global model, when it is unable to infer a response with sufficient confidence. The global model may provide a global insight, which the local model may integrate into its response and knowledge base. In addition, the global model may identify local insights from the local model's responses, and integrate those local insights into its knowledge base.

### CROSS-REFERENCE TO RELATED APPLICATION

This application claims priority to Indian Patent Application No. 202411081538, filed on Oct. 25, 2024, which is hereby incorporated herein by reference as if set forth in full.

### BACKGROUND

### Field of the Invention

The embodiments described herein are generally directed to artificial intelligence (AI), and, more particularly, to a hybrid AI architecture with an iterative local-global model feedback loop for continuous learning.

### Description of the Related Art

Artificial intelligence (AI) has become increasingly prevalent across a wide range of applications. AI systems typically rely on complex machine-learning models, trained on large datasets, to perform the intended tasks. However, deploying and scaling such complex models presents several challenges in terms of balancing performance, computational efficiency, adaptability, and the like.

Traditional AI architectures utilize a centralized approach, in which a single large global AI model is trained and deployed to handle all inference tasks. While this approach can provide high accuracy, it typically results in high latency, requires significant computational resources, has difficulty adapting to local data distributions or evolving data patterns, and raises privacy concerns when dealing with sensitive data.

Hybrid AI architectures have been developed to address these problems. A hybrid AI architecture comprises both a large global model and one or more smaller local models. Such an approach leverages the power of the large global model, while also benefitting from the small local model(s), which have lower latency, higher computational efficiency, and better adaptability.

Current hybrid AI architectures primarily rely on static distillation processes, in which knowledge is transferred once from the large global model to the smaller local model(s). After this one-time transfer of knowledge, the local model(s) operate and evolve independently of the global model. While federated learning frameworks involve periodic synchronization of model parameters, they do not provide real-time model adjustments or continuous refinement of the models. Single-step cascading architectures primarily use the local models as filtering layers, and escalate queries that are not filtered out by the local models to the global model. These architectures suffer from static knowledge bases, limited adaptability to data, and a lack of continuous learning, which reduces the accuracy of their outputs.

### SUMMARY

Accordingly, systems, methods, and non-transitory computer-readable media are disclosed for a hybrid AI architecture with an iterative local-global model feedback loop for continuous learning.

In an embodiment, a method comprises using at least one hardware processor to, during a real-time chat session between a user and an artificial intelligence (AI) application, by the AI application, in each of one or more iterations: receive an input; apply a local AI model to the input to generate a response to the input; when a confidence of the response satisfies one or more criteria, output the response; and when the confidence of the response does not satisfy the one or more criteria, escalate the input to a global AI model that is remote from the AI application, receive a global insight from the global AI model, integrate the global insight into the response to produce a refined response, update a local knowledge base of the local AI model based on the global insight, and output the refined response.

The method may further comprise using the at least one hardware processor, during the real-time chat session, by the AI application, in each of the one or more iterations, when the confidence of the response does not satisfy the one or more criteria: receive feedback for the refined response; and provide the feedback to the global AI model.

The global AI model may be a large language model, and the local AI model may be a small language model. The small language model may be distilled from the large language model.

The AI application may be an AI agent that comprises the local AI model The AI agent may be executed within a runtime engine on an on-premise system, and the global AI model may be executed within a computing cloud that is remote from the on-premise system.

The local AI model may output a confidence value for the response to the input, wherein the confidence of the response satisfies the one or more criteria when the confidence value satisfies a confidence threshold, and does not satisfy the one or more criteria when the confidence value does not satisfy the confidence threshold.

Escalating the input to the global AI model may comprise establishing a connection with a global AI application that comprises the global AI model, via an application programming interface of the global AI application. The connection may be an asynchronously coupled connection.

Escalating the input to the global AI model may comprise sending a request to the global AI model, wherein the request comprises the input, a context window of the local AI model, and the response generated by the local AI model.

Integrating the global insight into the response may comprise, in each of one or more sub-iterations, applying the local AI model to relevant data, comprising the input and the global insight, to generate a new response; when the confidence of the new response does not satisfy the one or more criteria, escalating the input to the global AI model, and receiving a new global insight from the global AI model; and when the confidence of the new response satisfies the one or more criteria, ending the one or more sub-iterations, and outputting the new response as the refined response.

Applying the local AI model to the input may comprise: processing the input to generate a search query; querying the local knowledge base using the search query to retrieve relevant data; generating a prompt based on the input and the relevant data; and inputting the prompt to the local AI model to generate the response to the input.

The AI application may be a local AI application; and escalating the input to the global AI model may comprise establishing a connection with a global AI application that comprises the global AI model, via an application programming interface of the global AI application, and sending a request to the global AI application, and the method may further comprise, by the global AI application: receiving the request from the local AI application; applying the global AI model to the request to generate the global insight; and sending the global insight to the local AI application. The request may comprise the response generated by the local AI model, wherein the method further comprises, by the global AI application, analyzing the request to identify a local insight from the response. The method may further comprise, by the global AI application, updating a global knowledge base based on the local insight. Applying the global AI model to the request may comprise: processing the request to generate a search query; querying a global knowledge base using the search query to retrieve relevant data; generating a prompt based on the request and the relevant data; and inputting the prompt to the global AI model to generate the global insight. The method may further comprise, by the global AI application: receiving feedback from the local AI application; and updating one or both of the global AI model or a global knowledge base based on the feedback. The global AI application may reside in a computing cloud that hosts an integration platform as a service (iPaaS) platform.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates a local process for an iterative local-global model feedback loop, according to an embodiment; and

FIG. 4 illustrates a global process for an iterative local-global model feedback loop, according to an embodiment.

### DETAILED DESCRIPTION

In an embodiment, systems, methods, and non-transitory computer-readable media are disclosed for a hybrid AI architecture with an iterative local-global model feedback loop for continuous learning. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

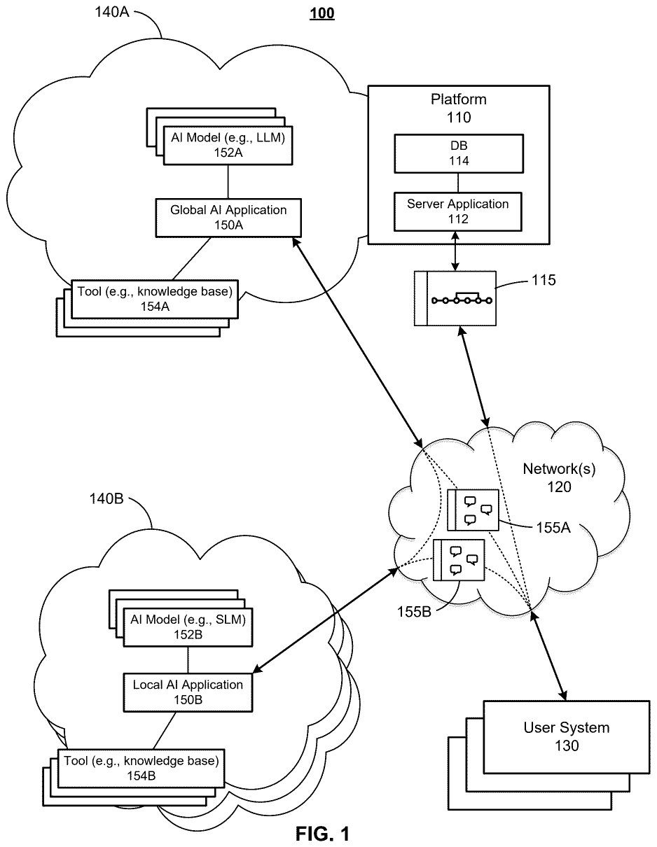

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112, and/or host a database 114 that may store data used by server application 112. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of a user that has a user account for accessing server application 112, a computing environment 140, and/or one or more artificial intelligence (AI) applications 150 within computing environment 140.

As used herein, a reference numeral with an appended letter will be used to refer to a specific component, whereas the same reference numeral without any appended letter will be used to refer collectively to a plurality of the component or to refer to a generic or arbitrary instance of the component. Thus, for example, the term “AI applications 150” refers collectively to global AI application 150A and local AI application 150B, and the term “AI application 150” may refer to any single, arbitrary one of global AI application 150A or local AI application 150B.

Server application 112 may manage a first computing environment 140A, which may also be referred to herein as a “global” computing environment. In an embodiment, global computing environment 140A may be an integration platform or an integration-platform-as-a-service (iPaaS) platform. Global computing environment 140A may be hosted in a computing cloud in which the resources of one or more servers are dynamically and elastically allocated to multiple tenants based on demand. It is generally contemplated that global computing environment 140A will have significant computational resources, including processing resources, memory resources, data-storage resources, communication resources, and/or the like.

In an embodiment in which global computing environment 140A is an iPaaS platform, server application 112 may provide a user interface 115 and backend functionality to enable users, via user systems 130, to construct, develop, modify, save, delete, test, deploy, un-deploy, and/or otherwise manage integration processes, within respective integration platforms, within global computing environment 140A. User interface 115 may comprise a graphical user interface that implements a low-code environment, including potentially a no-code environment, in which users may construct integration processes. For instance, the functionality of server application 112 may include a process for constructing an integration process within one or more screens of a graphical user interface of user interface 115. Embodiments of such functionality are disclosed, for example, in U.S. Pat. No. 8,533,661, issued on Sep. 10, 2013, and U.S. Pat. No. 11,886,965, issued on Jan. 30, 2024, which are both hereby incorporated herein by reference as if set forth in full. In particular, these applications describe functionality that enable the construction of integration processes on a virtual canvas.

An integration process may represent a transaction involving the integration of data between two or more systems, and may comprise a series of elements that specify logic and transformation requirements for the data to be integrated. Each element, which may also be referred to herein as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

Infrastructure 100 may also comprise one or more second computing environments 140B, which may also each be referred to herein as a “local” computing environment. A local computing environment 140B may be a runtime engine. For example, local computing environment 140B may be a lightweight, dynamic runtime engine that supports an integration platform, a portion of an integration platform, or other software system. In particular, the runtime engine may comprise all of the logic and data necessary to execute one or more integration processes and/or other software entities. The runtime engine may be an atomic, portable data structure that can be easily moved between systems, replicated, dynamically scaled up into multiple instances when demand increases, dynamically scaled down into fewer instances when demand decreases, and/or the like.

Local computing environment 140B is illustrated as being remote from global computing environment 140A (e.g., separated by network(s) 120). For instance, local computing environment 140B may reside on an on-premises system, while global computing environment 140A resides in a computing cloud. However, a local computing environment 140B is not necessarily remote from global computing environment 140A. For instance, in alternatives, a local computing environment 140B may reside within the same computing cloud as global computing environment 140A, and potentially even within global computing environment 140A itself.

Each local computing environment 140B (e.g., runtime engine) may be allocated a fixed or elastic set of computational resources by the system on which that runtime engine is hosted. Computational resources may include, without limitation, processing capacity, memory capacity, data-storage capacity, network capacity, and/or the like. The set of computational resources allocated or available to local computing environment 140B may be significantly less (e.g., by orders of magnitude, such as ten times fewer, one hundred times fewer, one thousand times fewer, ten thousand times fewer, one hundred thousand times fewer, hundreds of thousands times fewer, one million times fewer, tens of millions times fewer, hundreds of millions times fewer, billions times fewer, tens of billions times fewer, hundreds of billions times fewer, trillions of times fewer, tens of trillions times fewer, hundreds of trillions times fewer, quadrillions times fewer, etc.) than the computational resources allocated or available to global computing environment 140A. Thus, local computing environment 140B is much more limited in the software entities that it can run, whereas global computing environment 140A may be comparatively unlimited in the software entities that it can run, in terms of resource requirements, complexity, size, quantity, and the like.

Global computing environment 140A may comprise one or more, and generally a plurality of, software entities, including at least one global AI application 150A, and potentially one or more integration platforms and/or integration processes. Similarly, local computing environment 140B may comprise one or more, and generally a plurality of, software entities, including at least one local AI application 150B, and potentially an integration platform and/or one or more integration processes.

Each of global AI application 150A and local AI application 150B may be an AI agent. An AI agent is any software entity that utilizes artificial intelligence (e.g., machine learning, natural-language processing, data analytics, etc.) to autonomously perform a task, in order to achieve a goal set by a human, other AI agent, or other system. An AI agent may collect data, analyze data, learn and improve, communicate with human users and/or other software entities, collaborate with other AI agents to complete a complex task, execute actions, and/or the like.

An AI agent may be utilized within the context of an iPaaS platform to autonomously perform integration-related tasks, such as customer support, software design, code generation, conversational assistance, and the like. For example, an AI agent could be used to automatically map and/or transform data, orchestrate and/or optimize workflows, identify patterns and predict potential issues with integration processes, detect and/or resolve errors in integration processes, design steps in an integration process and/or entire integration processes based on a natural-language input from a user, otherwise interact with users through natural language, dynamically scale and adjust integration processes and/or the runtimes in which they execute, detect and/or mitigate security threats or compliance risks, identify and protect personally identifiable information, discover application programming interfaces (APIs), optimize API calls, monitor parameters of integration processes and/or integration platforms in real time for real-time alerts, provide next-step best practices, document integration processes (e.g., for improved version control), provide technical support, streamline data synchronization, enhance data quality, and/or the like.

Each AI application 150 (e.g., AI agent) may comprise or be communicatively coupled to at least one AI model 152. In the event that AI model 152 is external to AI application 150, AI application 150 may communicate with AI model 152 via an application programming interface of AI model 152. Otherwise, when AI model 152 is integrated into AI application 150, other functions of AI application 150 may communicate with AI model 152 using standard intra-process communications.

An AI model 152 may be a generative AI model, such as a generative language model (e.g., small language model, large language model, etc., that responds to natural-language prompts in natural language), generative image model (e.g., that responds to a natural-language prompt with an image), generative video model (e.g., that responds to a natural-language prompt with a video), generative coding model (e.g., that responds to a natural-language prompt with software code), or the like. One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as a well-known example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude Opus, Claude Sonnet, etc.) developed by Anthropic PBC of San Francisco, California, the Falcon large language model (e.g., Falcon 160B) released by the United Arab Emirates'Technology Innovation Institute (TII), the Large Language Model Meta AI (LLaMA) model (e.g., LLaMA 2) released by Meta AI of New York, New York, any of the Gemini family of large language models from Google LLC of Mountain View, California, any of the Mistral family of models released by Mistral AI of Paris, France, and the like. Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like. Examples of generative coding models include, without limitation, Codex from OpenAI, AlphaCode from Google LLC, Code LLaMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like. A pre-trained generative AI model may be used as a base model that is fine-tuned for the specific task of AI application 150, to produce AI model 152.

Each AI application 150 may comprise or be communicatively coupled to zero, one, or a plurality of tools 154. In the event that a tool 154 is external to AI application 150, AI application 150 may communicate with the tool 154 via an application programming interface of tool 154. Tool(s) 154 may be hosted within the same computing environment 140 as the respective AI application 150 and/or externally to the computing environment 140 in which the respective AI application 150 is hosted. Each tool 154 may perform a sub-task for the overall task of AI application 150. A sub-task may comprise retrieving data from a source (e.g., another AI application 150, a local database hosted within computing environment 110, a remote database hosted externally to computing environment 110, a third-party system, application, or database, an integration process, etc.), transforming, formatting, mapping, cleaning, or otherwise manipulating data, analyzing data, storing data, sending data (e.g., tabular or other structured data, unstructured data, commands, requests, queries, etc.) to a destination (e.g., another AI application 150, a local database, a remote database, a third-party system, application, or database, an integration process, etc.), initiating a transaction (e.g., purchase, sale, exchange, trade, etc.), completing a transaction, actuating a physical device (e.g., switch, motor, etc.), and/or the like.

Global AI application 150A may comprise or be communicatively coupled to at least one AI model 152A, which may also be referred to herein as “global” AI model 152A. Global AI model 152A may be a large language model (LLM). As one example, the large language model may be Claude Sonnet. However, it should be understood that global AI model 152A may be any other large language model, including any of the other large language models specifically mentioned elsewhere herein or not specifically mentioned herein. Global AI application 150A may also comprise or be communicatively coupled to at least one tool 154A. Of particular relevance to discloses embodiments, at least one tool 154A may comprise a global knowledge base that is used by global AI model 152A.

In an embodiment, global AI application 150A implements a retrieval-augmented generation (RAG) architecture. The RAG architecture combines a retrieval-based component, represented, for example, by the global knowledge base (e.g., tool 154A), with a generation-based component, represented, for example, by the large language model (e.g., global AI model 152A). In response to an input, global AI application 150A may retrieve information from the global knowledge base, and then generate a response by applying the large language model to the retrieved information. The RAG architecture provides dynamic and scalable access to the global knowledge base, improved generalization (e.g., enabling global AI model 152A to respond to prompts beyond those for which global AI model 152A was trained), and reduced model size (e.g., since global AI model 152A does not need to store all relevant data internally). Suitable enhancements to the RAG architecture, which may be used, include Chunked RAG (CRAG), in which the retrieval-based component retrieves relevant chunks of the knowledge base, and Self-RAG, in which the retrieval-based component is able to retrieve relevant data from a store of prior responses, as well as the global knowledge base.

Global AI application 150A may be a chat agent that is configured to engage in real-time chat sessions with users. In this case, global AI application 150A may have a chat interface 155A, into which users may submit inputs (e.g., queries, requests, etc.), and global AI application 150A may provide responses. These inputs and/or responses may comprise or consist of natural language. As used herein, the term “natural language” or “natural-language” refers to language, including grammar, that would be expected in a normal conversation between humans. It should be understood that global AI application 150A may utilize the large language model (e.g., global AI model 152A) to generate natural-language responses. In an alternative embodiment, global AI application 150A may only interact with other AI applications 150 and/or other software entities, and not human users, in which case chat interface 155A may be omitted.

Local AI application 150B may comprise or be communicatively coupled to at least one AI model 152B, which may also be referred to herein as “local” AI model 152B. Local AI model 152B may be a small language model (SLM). The small language model may be distilled from the large language model of global AI model 152A of global AI application 150A. Distillation is a process in machine-learning in which a smaller, more efficient model, referred to as the “student model,” is trained to mimic the behavior and knowledge of a larger, more complex model, referred to as the “teacher model.” Generally, this training involves using the teacher model to generate outputs for a wide range of inputs. These outputs are used as soft targets to provide a probability distribution over possible outputs. Then, the student model is trained using the data generated by the teacher model, with the goal of mimicking the teacher model's outputs and reasoning patterns. After this initial distillation, the student model may be further fine-tuned on domain-specific datasets related to the task of local AI application 150B. The result is a student model that is computationally faster and less expensive (i.e., requires fewer computational resources) than the teacher model—and therefore, more suitable for a local runtime engine—but which produces similar outputs as the teacher model. Each student model may be periodically updated, after the initial distillation, by subsequent incremental distillations from the teacher model, for example, according to a distillation cycle. Thus, as the teacher model improves its knowledge and accuracy over time, these improvements can be transferred to the student model(s).

Local AI application 150B may also comprise or be communicatively coupled to at least one tool 154B. Tool(s) 154B may comprise a local knowledge base. The local knowledge base may be distilled from the global knowledge base (e.g., tool 154A) of global AI application 150A, and/or enhanced with domain-specific information related to the task of local AI application 150B.

In an embodiment, similarly to global AI application 150A, local AI application 150B implements a RAG architecture. For example, the local knowledge base (e.g., tool 154B) may represent the retrieval-based component, and the small language model (e.g., AI model 152B) may represent the generation-based component. In response to an input, local AI application 150B may retrieve information from the local knowledge base, and then generate a response by applying the small language model to the retrieved information.

In an embodiment, the RAG architecture of the global AI application 150A and/or local AI application 150B employ dense vector embeddings generated through sentence transformers to capture semantic meaning. In other words, the global knowledge base and/or local knowledge base may store information in dense embedding vectors (i.e., in which most dimensions have non-zero values) within a multi-dimensional vector space (e.g., with one-hundred or more dimensions) that represents semantic meaning. The retrieval component may utilize one or more approximate nearest neighbor algorithms for efficient searching of embedding vectors within the vector space. Examples of approximate nearest neighbor algorithms include, without limitation, Facebook AI Similarly Search (FAISS), Hierarchical Navigable Small World (HNSW), Locality-Sensitive Hashing (LSH), Approximate Nearest Neighbors Oh Yeah (ANNOY), and the like. As an example, a FAISS/HNSW search may be used for efficient vector searching. The local knowledge base may implement quantized embedding vectors to reduce the memory footprint of the local knowledge base, while the global knowledge base may maintain full-precision embedding vectors. A quantized embedding vector is a compressed version of a full-precision embedding vector, in which the precision of the numerical values for the plurality of dimensions has been reduced. In addition, the RAG architectures of global AI application 150A and/or local AI application 150B may combine sparse retrieval (e.g., Best Match 25 (BM25)/Term-Frequency-Inverse Document Frequency (TF-IDF)) with dense vector retrieval, and employ dynamic chunking strategies for optimal context retrieval.

Local AI application 150B may be a chat agent that is configured to engage in real-time chat sessions with users. In this case, local AI application 150B may have a chat interface 155B, into which users may submit inputs (e.g., queries, requests, etc.), and local AI application 150B may provide responses. These inputs and/or responses may comprise or consist of natural language. It should be understood that local AI application 150B may utilize a small language model (e.g., local AI model 152B) to generate natural-language responses.

### 2. Example Processing System

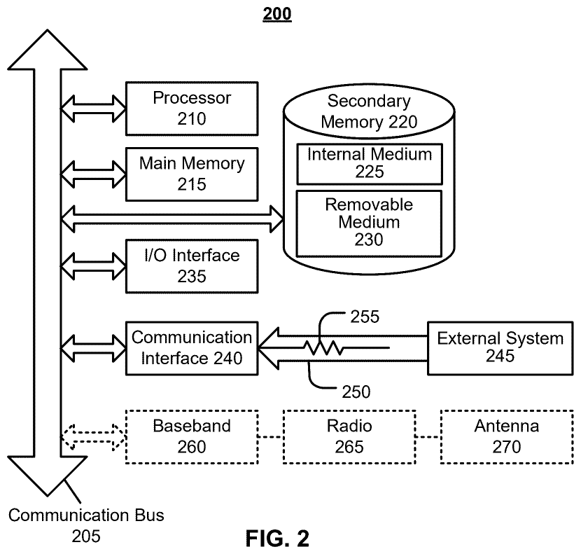

FIG. 2 illustrates an example processing system, by which one or more of the processes described herein may be executed, according to an embodiment. For example, system 200 may be used to store and/or execute server application 112, computing environments 140, AI applications 150, and/or may represent components of platform 110, user system(s) 130, computing environments 140, and/or the like. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Local Process

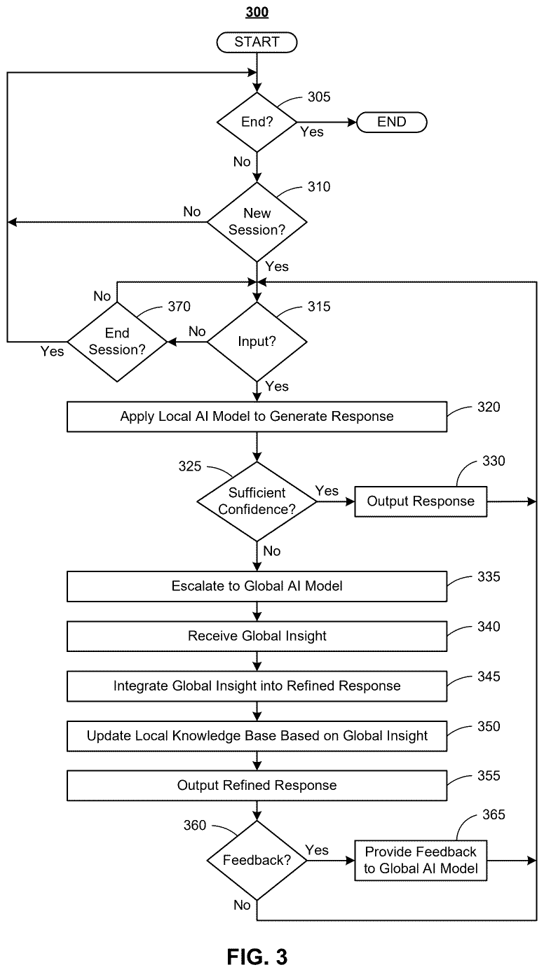

FIG. 3 illustrates a local process 300 for an iterative local-global model feedback loop, according to an embodiment. Process 300 may be implemented by local AI application 150B (e.g., a main or core thread of local AI application 150B). While process 300 is illustrated with a certain arrangement and ordering of subprocesses, process 300 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 305 may determine whether or not to end process 300. Process 300 may be performed for as long as local AI application 150B is operational. Once local AI application 150B has been deployed, process 300 may be performed until local AI application 150B is undeployed or otherwise terminated. For as long as the operation of local AI application 150B continues (i.e., “No” in subprocess 305), process 300 may proceed to subprocess 310. Otherwise, when the operation of local AI application 150B ends (i.e., “Yes”in subprocess 305), process 300 may end.

Subprocess 310 may determine whether or not to initiate a new session between a user and local AI application 150B. The initiation of a new session may be triggered by a user operation, such as the selection of an input by the user within a graphical user interface (e.g., dashboard) that provides access to local AI application 150B, the navigation of the user to chat interface 155B, and/or the like. When determining to initiate a new session (i.e., “Yes” in subprocess 310), process 300 may proceed to subprocess 315 to begin the new session. Otherwise, while not determining to initiate a new session (i.e., “No” in subprocess 310), process 300 may return to subprocess 305, for example, to await the initiation of a new session or the end of process 300.

In a contemplated embodiment, each session is a real-time chat session, in which a user interacts with local AI application 150B using natural-language inputs, and local AI application 150B interacts with the user using natural-language responses. In other words, each of the inputs and the responses comprises a natural-language expression. The natural-language inputs and/or responses may be provided in a textual format and/or audio format (e.g., using a speech-to-text engine to convert the user's speech to text to be processed by local AI application 150B, and/or a text-to-speech engine to convert the textual response of local AI application 150B into speech to be output to the user). In some cases, the responses from local AI application 150B may comprise non-textual visual elements, such as images, videos, animations, slides, diagrams, storyboards, charts, graphical user interfaces, and/or other graphical content, potentially in combination with textual visual elements and/or audio elements.

Over the course of a session with a user, local AI application 150B will gather context for the session. In particular, the small language model (e.g., AI model 152B) may utilize a context window to generate responses. This context window is the amount of tokens that the small language model can process for a single input. Essentially, the context window represents the working memory of the small language model. It should be understood that, when the total number of tokens in a session exceeds the context window, the least recent tokens will drop out of the context window.

Subprocess 315 may determine whether or not a new input has been received within the session. For example, the user may type a textual input into a textbox within chat interface 155B and then select an input to submit the textual input, speak an audio input into an audio interface of chat interface 155B (e.g., which may then be converted to text via a speech-to-text engine), or the like. More generally, the input may be received from a user (e.g., in the context of a real-time chat session), and may comprise or consist of a natural-language expression. Alternatively, the input may be received from another AI application 150, an integration process, a third-party application, or the like. When determining that a new input has been received (i.e., “Yes” in subprocess 315), process 300 may proceed to subprocess 320. Otherwise, while not determining that a new input has been received (i.e., “No” in subprocess 315), process 300 may proceed to subprocess 370.

A concrete example will now be provided and subsequently referred to herein, in order to facilitate an understanding of disclosed embodiments. It should be understood that the provided example is a simple one, and is not limiting in any manner. In this concrete example, the input received in subprocess 315 is:
Integration job ‘salesforce-to-netsuite’ intermittently fails with Error 405.

This input may be submitted by the user as a query to local AI application 150B, which may be executing within local computing environment 140B (e.g., a runtime engine), to aid users in troubleshooting integration processes of their organizations'integration platforms.

Subprocess 320 may, when a new input is received in subprocess 315, apply local AI model 152B to the input to generate a response to the input. In particular, local AI application 150B may generate a prompt based on the input, for example, by inserting the input, potentially along with other relevant data, including the context window, into a predefined template. The predefined template may comprise a pre-conversation and/or post-conversation, which provide context and/or instructions for local AI model 152B, and one or more placeholders into which the input and/or other relevant data are inserted. The pre-conversation and/or post-conversation may define the role of local AI model 152B (e.g., to respond to the input, given the context window), define an output format for local AI model 152B (e.g., a natural-language expression, a list structure, a hierarchical structure, a markup-language structure, etc.), and/or the like.

In an embodiment, local AI application 150B implements a RAG architecture. In such an embodiment, local AI application 150B firstly retrieves relevant data from the local knowledge base, represented by tool 154B. For example, local AI application 150B may process the input, via natural language processing (NLP), such as named entity recognition, to generate a search query (e.g., comprising named entities and/or other tokens identified within the input), and query the local knowledge base using the generated search query (e.g., via an application programming interface of tool 154B). The local knowledge base will return a response, which may comprise the results of the search query, including any data in the local knowledge base that are relevant to the input. Local AI application 150B may incorporate this retrieved data, along with the input, and other relevant data, such as the context window, into a prompt, and input the prompt into local AI model 152B to generate the response, which may comprise or consist of a natural-language expression. As discussed elsewhere herein, local AI model 152B may comprise or consist of a small language model.

As mentioned elsewhere herein, local AI model 152B may be a small language model that is distilled from global AI model 152A, which may be a large language model. The small language model may then be optimized for a specific domain or task. In addition, the local knowledge base may be a lightweight data repository (e.g., local data lake-house) that is distilled from the global knowledge base, which may be a massive data repository (e.g., global data lake). In subprocess 320, the distilled local AI model 152B attempts an initial inference based on the local knowledge base. In the concrete example used herein, the local knowledge base may comprise stored troubleshooting knowledge for integration processes and/or platforms, and local AI model 152B may be fine-tuned for troubleshooting integration processes.

Subprocess 325 may determine whether or not a confidence of the response, generated by local AI model 152B in subprocess 320, satisfies one or more criteria. In particular, local AI model 152B may output a confidence value with the response that was generated in subprocess 320. The confidence value may be a discrete or continuous value, within a fixed numerical range (e.g., a real number between zero and one), which represents the local AI model's internal estimate of how certain it is that its response is correct for the given input and/or how complex the input is. The one or more criteria may comprise or consist of the confidence value satisfying a predefined confidence threshold (e.g., 0.50, 0.55, 0.60, 0.65, 0.70, 0.75, 0.80, 0.85, 0.90, 0.95, etc., in an embodiment in which the numerical range is zero to one). In this case, the confidence of the response satisfies the one or more criteria when the confidence value is greater than or equal to the predefined threshold, and does not satisfy the one or more criteria when the confidence value is less than the predefined threshold. When the confidence of the response satisfies the one or more criteria (i.e., “Yes” in subprocess 325), global AI model 152A is not needed, and process 300 may proceed to subprocess 330. Otherwise, when the confidence of the response does not satisfy the one or more criteria (i.e., “No” in subprocess 325), global AI model 152A is needed, and process 300 may proceed to subprocess 335.

Subprocess 330 may output the response that was generated by local AI model 152B in subprocess 320. Assuming that the input was received from a user, the response may be output to the user, for example, within a graphical user interface of chat interface 155B, through a speaker of an audio user interface of chat interface 155B, and/or the like. Subprocess 330 may comprise formatting the response into a visual representation that can be displayed within the graphical user interface of chat interface 155B, converting the response from text to speech using a text-to-speech engine for playback at a user system 130, and/or the like. After outputting the response, process 300 may return to subprocess 315.

Although not specifically illustrated, feedback may be received for the response that was output in subprocess 330. For example, the feedback may be provided as the selection of an input (e.g., a first input representing approval of the response, or a second input representing disapproval of the response) within the graphical user interface of chat interface 155B, a subsequent input comprising a positive or negative sentiment about the response, and/or the like. In the event that feedback is received, local AI application 150B may update local AI model 152B (e.g., small language model) and/or the local knowledge base (e.g., tool 154B) based on the feedback.

Subprocess 335 may escalate the input, received in subprocess 315, to global AI model 152A, which may be remote from local AI application 150B. In particular, local AI application 150B may establish a connection with global AI application 150A, for example, via an application programming interface of global AI application 150A and/or computing environment 140A, and send a request to global AI model 152A, via the connection to global AI application 150A. The request may comprise the input, the context window of local AI model 152B, the local response generated by local AI model 152B, and/or other relevant data. The connection may be an asynchronously coupled connection (e.g., via a runtime message proxy and service API gateway), which enables local AI application 150B to continue executing other tasks while waiting for the global AI application's response.

Continuing the concrete example above, the confidence value of the response, generated by local AI model 152B, may be moderate to low, due to the intermittent nature of the failure and the specificity of the error. This confidence value may be less than the predefined confidence threshold (i.e., “No” in subprocess 325), such that local AI application 150B escalates the input to global AI model 152A in subprocess 335.

Subprocess 340 may receive a global insight from global AI model 152A. In particular, global AI application 150A, when receiving the request with relevant data (e.g., the input, context window, local response, etc.) from local AI application 150B, may apply global AI model 152A to the relevant data to generate a response to the request. The global insight may comprise or consist of the global AI model's response to the request. As with local AI application 150B, global AI application 150A may utilize a RAG architecture comprising a retrieval of knowledge from the global knowledge base (e.g., tool 154A), based on at least a portion of the relevant data (e.g., input) in the request, and the generation of a response using global AI model 152A, which may be a large language model. Global AI application 150A may return the global insight to local AI application 150B, for example, in an asynchronous manner over the asynchronously coupled connection.

Continuing the concrete example above, the global knowledge base may comprise a massive repository that aggregates extensive historical integration data, including detailed error logs, across multiple users, organizations, integration platforms, and/or the like, collected during operation of platform 110. For instance, platform 110 may be an iPaaS platform which collects data from a plurality of integration platforms operated by a plurality of different users for a plurality of different organizations. Global AI model 152A may determine that the “Error 405” in the input often indicates authentication mismatches or timeout issues in the configurations of load balancers, and identify detailed remedial actions. Global AI application 150A may return this information, including the determination of the error and the detailed remedial actions, to local AI application 150B as the global insight.

Subprocess 345 may integrate the global insight, received in subprocess 340, into the response, generated by local AI model 152B in subprocess 320, to produce a refined response. In an embodiment, local AI application 150B integrates the global insight, iteratively, to refine the inference result. For example, local AI application 150B may apply local AI model 152B to the relevant data (e.g., the input, context window, data retrieved from the local knowledge base, etc.), the response generated by local AI model 152B with insufficient confidence, and/or the global insight. In this case, local AI application 150B may generate a prompt that incorporates the relevant data, response, and/or global insight, and input the prompt to local AI model 152B, to generate the refined response. In an embodiment, if the refined response still does not have sufficient confidence (e.g., if the confidence value output by local AI model 152B does not satisfy the predefined confidence threshold), process 300 could again escalate the input to global AI model 152A with a new request (e.g., comprising the input, context window, and refined response), and this may continue iteratively until local AI model 152B has sufficient confidence in the refined response, at which point, process 300 may proceed to subprocess 350. In other words, subprocess 345 may comprise one or iterations of subprocesses 320-325-335-340, until the confidence value for the refined response satisfies the confidence threshold. In particular, subprocess 345 may comprise, in each of one or more sub-iterations: applying the local AI model to relevant data, comprising the input, the global insight, and/or other relevant data, to generate a new response (e.g., in a similar or identical manner as subprocess 320); when the confidence of the new response does not satisfy the one or more criteria (e.g., in a similar or identical manner as “No” in subprocess 325), escalating the input to the global AI model (e.g., in a similar or identical manner as subprocess 335), and receiving a new global insight from the global AI model (e.g., in a similar or identical manner as subprocess 340); and when the confidence of the new response satisfies the one or more criteria, ending the one or more sub-iterations, and outputting the new response as the refined response. Alternatively, in an embodiment in which the global insight is provided as a natural-language expression, generated by global AI model 152A, the refined response may simply consist of the global insight.

Continuing the concrete example above, local AI model 152B may iteratively integrate the global insight, over one or more iterations in subprocess 345, to generate the following refined response:
Error 405 typically results from authentication mismatches or timeouts in load balancer configurations. You should verify your authentication credentials and increase the timeout window settings to resolve the intermittent issues.

Subprocess 350 may update the local knowledge base (e.g., tool 154B) of local AI model 152B based on the global insight, received in subprocess 340. In particular, local AI application 150B may update the local knowledge base to include the global insight, a portion of the global insight, or data otherwise derived from the global insight. In this manner, local AI application 150B may incorporate incremental knowledge updates anytime that an input must be escalated to global AI model 152A. As a result, the next time that a user submits a similar input, as was received in subprocess 315, local AI model 152B will likely be able to generate a response with sufficient confidence using the updated local knowledge base. It should be understood that subprocess 350 may occur simultaneously or concurrently with subprocess 340.

Subprocess 355 may output the refined response, produced in subprocess 345. Assuming that the input was received from a user, the response may be output to the user, for example, within a graphical user interface of chat interface 155B, through a speaker of an audio user interface of chat interface 155B, and/or the like. Subprocess 355 may comprise formatting the response into a visual representation that can be displayed within the graphical user interface of chat interface 155B, converting the response from text to speech using a text-to-speech engine for playback at a user system 130, and/or the like.

Notably, most inputs will require only local AI model 152B, and therefore, the initial response will be output in subprocess 330. Responses will only be refined and output in subprocess 355 when the local AI model 152B cannot infer a confident response. Thus, this hybrid architecture is able to quickly return highly confident responses with minimal latency.

Subprocess 360 may determine whether or not feedback has been received for the refined response that was output in subprocess 355. For example, the feedback may be provided as the selection of an input (e.g., a first input representing approval of the response, or a second input representing disapproval of the response) within the graphical user interface of chat interface 155B, a subsequent input comprising a positive or negative sentiment about the refined response, and/or the like. When feedback has been received for the refined response (i.e., “Yes” in subprocess 360), process 300 may proceed to subprocess 365. Otherwise, when no feedback is received for the refined response (i.e., “No” in subprocess 360), process 300 may return to subprocess 315.

Subprocess 365 may provide the feedback, received in subprocess 360, to global AI model 152A. In particular, local AI application 150B may establish a connection with global AI application 150A (or utilize the previously established connection), for example, via an application programming interface of global AI application 150A and/or computing environment 140A, and submit the feedback via the connection to global AI application 150A. Global AI application 150A may update global AI model 152A (e.g., large language model) and/or the global knowledge base (e.g., tool 154A) based on the feedback. Thus, global AI model 152A may be iteratively updated based on user feedback, to thereby improve the accuracy of future inferences and future distillation updates to local AI model 152B, via incremental distillation cycles.

It should be understood that the session, initiated in subprocess 310, may continue through one or more iterations of subprocesses 315-365. In each of the iteration(s), an input is received, local AI model 152B is applied to the input to generate a response, and, when there is insufficient confidence in the response by local AI model 152B, the input is escalated to global AI model 152A to obtain a global insight that can be used to refine the response and update local AI model 152B. In addition, feedback to a refined response may be provided to global AI model 152A, to update global AI model 152A. Thus, both global AI model 152A and local AI model 152B may be updated in an iterative local-global model feedback loop, during a session (i.e., during inference). In other words, user acceptances and model escalations are continuously fed back into the models via a dedicated feedback loop channel.

Subprocess 370 may determine whether or not to end the current session. Local AI application 150B may continue to respond to inputs (e.g., from a user), for as long as the session remains active. The end of a session may be triggered by a user operation, such as the selection of an input, by the user, within a graphical user interface that provides access to local AI application 150B, a vocal input spoken by the user and received via a microphone of user system 130, the navigation of the user away from chat interface 155B, the expiration of a timeout period after the most recent user input, and/or the like. When determining to end the session (i.e., “Yes” in subprocess 370), process 300 may return to subprocess 305 and await the end of process 300 or the initiation of a new session (e.g., by the same user or a different user). Otherwise, while not determining to end the session (i.e., “No” in subprocess 370), process 300 may return to subprocess 315 to await a new input. It should be understood that, when an action is described herein as being performed during a session, such as a real-time chat session, that action is being performed, in support of the session, at a point in time between the initiation of a new session (i.e., “Yes” in subprocess 310) and the end of a session (i.e., “Yes”in subprocess 370).

Notably, a single local AI application 150B may service a plurality of users. Thus, iterations of subprocesses 310-370 may be performed in parallel and/or in series for a plurality of different users, with each user interacting with the same local AI application 150B within a different, independent session, with a different context. In an embodiment, the same local AI application 150B may utilize different tool(s) 154 for different users. For example, two different users may have different on-premise systems, hosting their own respective organization-specific copy of the same tool 154B (e.g., local knowledge base). In this case, local AI application 150B may operate in an identical manner for each of the two users, but when needing to access tool 154B during one of the user's session, will access the respective organization-specific copy of tool 154B. Consequently, the operations of local AI application 150B may be identical for all users of all organizations, but still capable of providing organization-specific responses, due to the organization-specific data being provided by each organization's specific copy of each tool 154B.

### 4. Global Process

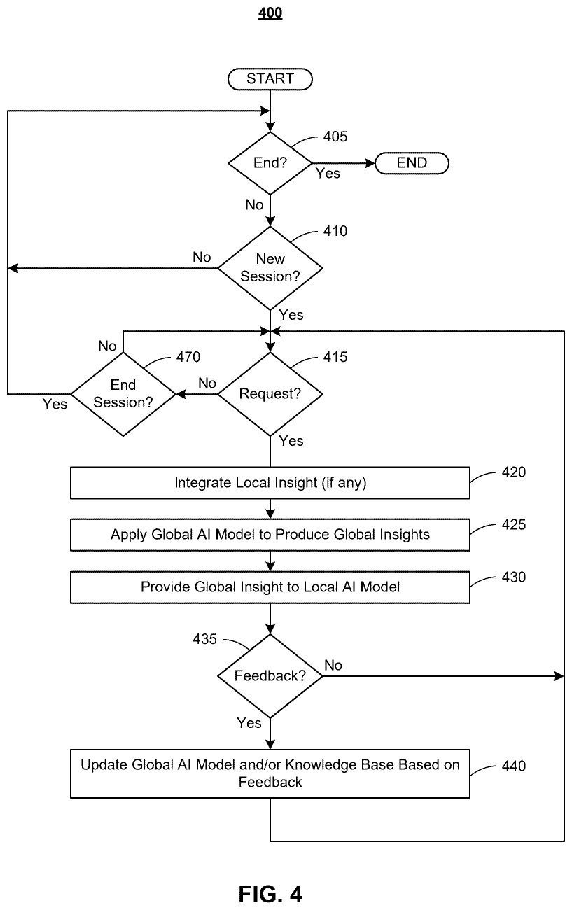

FIG. 4 illustrates a global process 400 for an iterative local-global model feedback loop, according to an embodiment. Process 400 may be implemented by global AI application 150A (e.g., a main or core thread of global AI application 150A). Global process 400 represents the global side of local process 300. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 405 may determine whether or not to end process 400. Process 400 may be performed for as long as global AI application 150A is operational. Once global AI application 150A has been deployed, process 400 may be performed until global AI application 150A is undeployed or otherwise terminated. For as long as the operation of global AI application 150A continues (i.e., “No” in subprocess 405), process 400 may proceed to subprocess 410. Otherwise, when the operation of global AI application 150A ends (i.e., “Yes” in subprocess 405), process 400 may end.

Subprocess 410 may determine whether or not to initiate a new session between a local AI application 150B and global AI application 150A. The initiation of a new session may be triggered by local AI application 150B establishing a connection (e.g., asynchronously coupled connection) with global AI application 150A. When determining to initiate a new session (i.e., “Yes” in subprocess 410), process 400 may proceed to subprocess 415 to begin the new session. Otherwise, while not determining to initiate a new session (i.e., “No” in subprocess 410), process 400 may return to subprocess 405, for example, to await the initiation of a new session or the end of process 400.

Subprocess 415 may determine whether or not a new request has been received within the session. For example, the request may comprise relevant data, such as an input received at local AI application 150B (e.g., from a user), a context window, the local response generated by local AI model 152B, and/or other relevant data. It should be understood that subprocess 415 represents the receiving side of a communication in subprocess 335 of process 300. When determining that a new request has been received (i.e., “Yes” in subprocess 415), process 400 may proceed to subprocess 420. Otherwise, while not determining that a new request has been received (i.e., “No” in subprocess 415), process 400 may proceed to subprocess 470.

Subprocess 420 may integrate any local insight, if any, within the local response generated by local AI model 152B, which may be included within the request, received in subprocess 415. In particular, global AI application 150A may analyze the local response generated by local AI model 152B, to identify a local insight from the local response. Even though this local response may not have been generated with sufficient confidence to avoid escalation by local AI application 150B, the local response may still contain a useful local insight. In the event that the local response does contain a local insight, global AI application 150A may update the global knowledge base (e.g., tool 154A) of global AI model 152A based on the local insight. In particular, global AI application 150A may update the global knowledge base to include or otherwise incorporate the local insight. In this manner, global AI application 150A may incorporate locally learned knowledge in incremental updates during inference by local AI application(s) 150B.

Subprocess 425 may, when a new request is received in subprocess 415, apply global AI model 152A to the request to generate a response (i.e., global insight) to the request. In particular, global AI application 152A may generate a prompt based on the request, for example, by inserting relevant data from the request, including the input, the context window, the local response generated by local AI model 152B, and/or the like, into a predefined template. The predefined template may comprise a pre-conversation and/or post-conversation, which provide context and/or instructions for global AI model 152A, and one or more placeholders into which the relevant data are inserted. The pre-conversation and/or post-conversation may define the role of global AI model 152A (e.g., to respond to the input, given the context window and/or local response), define an output format for global AI model 152A (e.g., a natural-language expression, a list structure, a hierarchical structure, a markup-language structure, etc.), and/or the like.

In an embodiment, global AI application 150A implements a RAG architecture. In such an embodiment, global AI application 150A firstly retrieves relevant data from the global knowledge base, represented by tool 154A. For example, global AI application 150A may process the request, via natural language processing (NLP), such as named entity recognition, to generate a search query (e.g., comprising named entities and/or other tokens identified within the request), and query the global knowledge base using the generated search query (e.g., via an application programming interface of tool 154A). The global knowledge base will return a response, which may comprise the results of the search query, including any data in the global knowledge base that are relevant to the request. Global AI application 150A may incorporate this retrieved data, along with other relevant data from the request (e.g., input, context window, local response, etc.), into a prompt, and input the prompt into global AI model 152A to generate a response, representing a global insight, which may comprise or consist of a natural-language expression. As discussed elsewhere herein, global AI model 152A may comprise or consist of a large language model.

Subprocess 430 may provide the global insight, generated in subprocess 425, to local AI model 152B. In particular, global AI application 150A may return the global insight to local AI application 150B, in response to the request that was received in subprocess 415 (e.g., via the application programming interface of global AI application 150A). It should be understood that subprocess 430 represents the sending side of the communication in subprocess 340 of process 300.

Subprocess 435 may determine whether or not feedback has been received for the global insight that was provided in subprocess 430, via the local AI application 150B to which the global insight was provided. It should be understood that subprocess 435 represents the receiving side of a communication in subprocess 365 of process 300. When feedback has been received for the global insight (i.e., “Yes” in subprocess 435), process 400 may proceed to subprocess 440. Otherwise, when no feedback is received for the global insight (i.e., “No” in subprocess 435), process 400 may return to subprocess 415.

Subprocess 440 may update global AI model 152A and/or the global knowledge base (e.g., tool 154A) based on the feedback, received in subprocess 435. Thus, global AI model 152A may be updated based on user feedback, even when the user is not providing feedback directly to global AI application 150A.

It should be understood that the session, initiated in subprocess 410, may continue through one or more iterations of subprocesses 415-440. In each of the iteration(s), a request is received, and global AI model 152A is applied to the request to generate a global insight, which is returned to local AI application 150B in response to the request. In addition, local insights and/or feedback, if any, may be used to improve the performance of global AI model 152A.

Subprocess 470 may determine whether or not to end the current session. The end of a session may be triggered by an operation by local AI application 150B (e.g., termination of an established connection), the expiration of a timeout period after the most recent request, and/or the like. When determining to end the session (i.e., “Yes” in subprocess 470), process 400 may return to subprocess 405 and await the end of process 400 or the initiation of a new session (e.g., by the same or different local AI application 150B). Otherwise, while not determining to end the session (i.e., “No”in subprocess 470), process 400 may return to subprocess 415 to await a new request.

Notably, a single global AI application 150A may service a plurality of local AI applications 150B. Thus, iterations of subprocesses 410-470 may be performed in parallel and/or in series for a plurality of different local AI applications 150B, with each local AI application 150B interacting with the same global AI application 150A within a different, independent session, with a different context. In an embodiment, the same global AI application 150A may utilize different tool(s) 154 for different local AI applications 150B. For example, two local AI applications 150B users may be hosted on different on-premise systems, hosting their own respective organization-specific copy of the same tool 154A (e.g., the global knowledge base). In this case, global AI application 150A may operate in an identical manner for each of the two local AI applications 150B, but when needing to access tool 154A during one of the sessions, will access the respective organization-specific copy of tool 154A. Consequently, the operations of global AI application 150A may be identical for all local AI applications 150B, but still capable of providing organization-specific global insights, due to the organization-specific data being provided by each organization's specific copy of each tool 154A.

### 5. Example Embodiment

Disclosed embodiments employ a hybrid AI architecture that combines a local distilled AI model 152B with a global AI model 152A, to engage in a feedback loop of multi-turn iterative reasoning and adaptive knowledge transfer, to thereby enable true continuous learning during inference. Local AI model 152B may be a compact, efficient small language model, designed for deployment on an on-premise system, that utilizes distilled knowledge from global AI model 152A, which may be executed within a computing cloud that is remote from the on-premise system. Local AI model 152B operates with reduced computational resources and latency, relative to global AI model 152A, and handles inference locally with high efficiency and privacy. On the other hand, global AI model 152A may be a high-capacity, cloud-hosted large language model, with an extensive global knowledge base and advanced reasoning capabilities.

Local AI model 152B handles inference efficiently and escalates uncertain tasks to global AI model 152A, dynamically. This reduces inference latency by effectively handling queries locally, and escalating only complex or uncertain requests iteratively. In addition, the real-time iterative dialogue between local AI model 152B and global AI model 152A enables the continuous refinement of inference results, providing real-time incremental distillation from global AI model 152A to local AI model 152B, which enables ongoing learning and performance improvement without disruptive offline training cycles. Global AI model 152A provides ongoing guidance, which allows local AI model 152B to dynamically update and optimize its knowledge, including dynamically updating its local knowledge base during inference, which continuously enhances adaptability and contextual accuracy. Furthermore, privacy and compliance are enhanced, since sensitive data are retained locally, which minimizes exposure during interactions with global AI model 152A. Thus, this continuous runtime interaction improves accuracy, efficiency, privacy, and adaptability for AI applications 150, in contrast to static distillation, periodic federated learning, or single-step inference cascades.

In an embodiment, the operational flow comprises initial input processing (e.g., subprocess 320). When an input is received, local AI model 152B first attempts inference based on its local knowledge base, which represents a lightweight data repository.

In an embodiment, the operational flow comprises a dynamic confidence evaluation (e.g., subprocess 325). After the initial inference by local AI model 152B, the confidence of the local AI model's response may be dynamically evaluated. This confidence may reflect the complexity of the input. If local AI model 152B achieves sufficient confidence in its response, the response may be output immediately, ensuring minimal latency.

In an embodiment, the operational flow comprises an iterative escalation to global AI model 152A (e.g., subprocess 335). If local AI model 152B fails to achieve sufficient confidence in its response, an iterative dialogue with global AI model 152A may be initiated.

In an embodiment, the operational flow comprises local knowledge updates (e.g., subprocesses 340-350). As part of the iterative dialogue between local AI model 152B and global AI model 152A, local AI model 152B may dynamically update its compact local knowledge base and/or internal parameters. This integrates incremental knowledge enhancements from global AI model 152.

In an embodiment, the operational flow comprises a feedback loop and continuous learning. Insights and refined outputs from the local-global interactions feed back into both local and global knowledge bases. This creates a continuous loop of adaptive learning and knowledge integration.

In an embodiment, the operational flow comprises real-time adaptive local model updates. Unlike conventional small language models, which rely on static distillation, local AI model 152B may support real-time incorporation of updated reasoning patterns, corrected factual inferences, and/or expanded schema representations via feedback from global AI model 152A. This can occur through lightweight adapter modules, episodic memory updates, embedding-based cache enhancements, and/or the like—all during inference. This enables local AI model 152B to improve autonomously over multiple user sessions without requiring retraining or offline synchronization or distillation.

In an embodiment, the operational flow comprises bidirectional model feedback that includes both global-to-local and local-to-global learning. This disclosed architecture facilitates optional upward knowledge transfer from local AI model 152B to global AI model 152A. For example, if a local AI model 152B discovers a new resolution pattern (e.g., a successful integration workaround that global AI model 152A has never seen before), this local insight can be selectively abstracted and integrated into the meta-learning buffer of global AI model 152A. Such bidirectional feedback closes the loop and promotes adaptive alignment across local AI model 152B and global AI model 152A over time.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, during a real-time chat session between a user and an artificial intelligence (AI) application, by the AI application, in each of one or more iterations:
receive an input;
apply a local AI model to the input to generate a response to the input;
when a confidence of the response satisfies one or more criteria, output the response; and
when the confidence of the response does not satisfy the one or more criteria,
escalate the input to a global AI model that is remote from the AI application,
receive a global insight from the global AI model,
integrate the global insight into the response to produce a refined response,
update a local knowledge base of the local AI model based on the global insight, and
output the refined response.

2. The method of claim 1, further comprising using the at least one hardware processor, during the real-time chat session, by the AI application, in each of the one or more iterations, when the confidence of the response does not satisfy the one or more criteria:
receive feedback for the refined response; and
provide the feedback to the global AI model.

3. The method of claim 1, wherein the global AI model is a large language model, and wherein the local AI model is a small language model.

4. The method of claim 3, wherein the small language model is distilled from the large language model.

5. The method of claim 1, wherein the AI application is an AI agent that comprises the local AI model.

6. The method of claim 5, wherein the AI agent is executed within a runtime engine on an on-premise system, and wherein the global AI model is executed within a computing cloud that is remote from the on-premise system.

7. The method of claim 1, wherein the local AI model outputs a confidence value for the response to the input, and wherein the confidence of the response satisfies the one or more criteria when the confidence value satisfies a confidence threshold, and does not satisfy the one or more criteria when the confidence value does not satisfy the confidence threshold.

8. The method of claim 1, wherein escalating the input to the global AI model comprises establishing a connection with a global AI application that comprises the global AI model, via an application programming interface of the global AI application.

9. The method of claim 8, wherein the connection is an asynchronously coupled connection.

10. The method of claim 1, wherein escalating the input to the global AI model comprises sending a request to the global AI model, wherein the request comprises the input, a context window of the local AI model, and the response generated by the local AI model.

11. The method of claim 1, wherein integrating the global insight into the response comprises, in each of one or more sub-iterations,
applying the local AI model to relevant data, comprising the input and the global insight, to generate a new response;
when the confidence of the new response does not satisfy the one or more criteria, escalating the input to the global AI model, and receiving a new global insight from the global AI model; and
when the confidence of the new response satisfies the one or more criteria, ending the one or more sub-iterations, and outputting the new response as the refined response.

12. The method of claim 1, wherein applying the local AI model to the input comprises:
processing the input to generate a search query;
querying the local knowledge base using the search query to retrieve relevant data;
generating a prompt based on the input and the relevant data; and
inputting the prompt to the local AI model to generate the response to the input.

13. The method of claim 1,
wherein the AI application is a local AI application;
wherein escalating the input to the global AI model comprises establishing a connection with a global AI application that comprises the global AI model, via an application programming interface of the global AI application, and sending a request to the global AI application, and
wherein the method further comprises, by the global AI application:
receiving the request from the local AI application;
applying the global AI model to the request to generate the global insight; and
sending the global insight to the local AI application.

14. The method of claim 13, wherein the request comprises the response generated by the local AI model, and wherein the method further comprises, by the global AI application, analyzing the request to identify a local insight from the response.

15. The method of claim 14, further comprising, by the global AI application, updating a global knowledge base based on the local insight.

16. The method of claim 13, wherein applying the global AI model to the request comprises:
processing the request to generate a search query;
querying a global knowledge base using the search query to retrieve relevant data;
generating a prompt based on the request and the relevant data; and
inputting the prompt to the global AI model to generate the global insight.

17. The method of claim 13, further comprising, by the global AI application:
receiving feedback from the local AI application; and
updating one or both of the global AI model or a global knowledge base based on the feedback.

18. The method of claim 13, wherein the global AI application resides in a computing cloud that hosts an integration platform as a service (iPaaS) platform.

19. A system comprising:
at least one hardware processor; and
an artificial intelligence (AI) application that is configured to, when executed by the at least one hardware processor, during a real-time chat session between a user and the AI application, in each of one or more iterations,
receive an input,
apply a local AI model to the input to generate a response to the input,
when a confidence of the response satisfies one or more criteria, output the response, and
when the confidence of the response does not satisfy the one or more criteria,
escalate the input to a global AI model that is remote from the AI application,
receive a global insight from the global AI model,
integrate the global insight into the response to produce a refined response,
update a local knowledge base of the local AI model based on the global insight, and
output the refined response.

20. A non-transitory computer-readable medium having instructions stored therein, wherein the instructions, when executed by a processor, cause the processor to, during a real-time chat session between a user and an artificial intelligence (AI) application, in each of one or more iterations:
receive an input;
apply a local AI model to the input to generate a response to the input;
when a confidence of the response satisfies one or more criteria, output the response; and
when the confidence of the response does not satisfy the one or more criteria,
escalate the input to a global AI model that is remote from the AI application,
receive a global insight from the global AI model,
integrate the global insight into the response to produce a refined response,
update a local knowledge base of the local AI model based on the global insight, and
output the refined response.
